(19) United States
(12) Patent Application Publication
(10) Pub. No.: US 2009/0317694 A1
(43) Pub. Date: Dec. 24, 2009

(54) Temperature controller

(75) Inventors: Lennart Ängquist, Enkoping (SE); Magnus Callavik, Stocksund (SE); Gerhard Brosig, Vasteras (SE); Willy Hermansson, Vasteras (SE); Per Halvarsson, Vasteras (SE); Stefan Johansson, Vasteras (SE); Bertil Nygren, Vasteras (SE); Gunnar Russberg, Vasteras (SE); Jan R. Svensson, Vasteras (SE)

Correspondence Address: VENABLE LLP, P.O. BOX 34385, WASHINGTON, DC, 20043-9998, US

(73) Assignee: ABB Research Ltd., Zurich (CH)

(21) Appl. No.: 12/281,991

(22) PCT Filed: Mar. 6, 2006
(86) PCT No.: PCT/SE2006/000289

§ 371 Date: Jan. 12, 2009

(51) Int. Cl. H01M 10/50; H01M 10/44; H01M 10/48

(52) U.S. Cl. 429/50; 429/120; 429/91

(57) ABSTRACT

A temperature controller for providing heat to an energy storage device of a power compensator. The energy storage device includes a plurality of high temperature battery units on high potential. The temperature controller includes a pipe network for housing a heat transfer medium. The pipe network includes a main pipe loop and a local pipe loop in each battery unit. Each local pipe loop includes a first end for receiving a heat transfer medium and a second end for exhausting the medium.

### TECHNICAL FIELD

The present invention concerns power compensation of a high voltage transmission line. By a transmission line should be understood a conductor for electric power transmission or distribution line within the range of 3 kV and upwards, preferably in the range of 10 kV and upwards. Especially the invention concerns a power compensator for providing an exchange of electric power on a high voltage transmission line. The apparatus comprises a voltage source converter (VSC) and an energy storage device. In particular the invention concerns the temperature control of the energy storage devise comprising high temperature batteries.

### BACKGROUND OF THE INVENTION

A plurality of apparatus and methods are known for compensation of reactive power on a transmission line. The most common apparatus comprises capacitor means or a reactor means capable of being controllably connected to the transmission line. The connecting means may preferably include a switch containing semiconducting elements. The semiconducting elements used in known applications commonly include a non-extinguishable element, such as a thyristor. These kinds of reactive power compensators are known as flexible alternating current transmission system (FACTS).

A known FACTS apparatus is a static compensator (STATCOM). A STATCOM comprises a voltage source converter (VSC) having an ac side connected to the transmission line and a dc side connected to a temporary electric power storage means such as capacitor means. In a STATCOM the voltage magnitude output is controlled thus resulting in the compensator supplying reactive power or absorbing reactive power from the transmission line. The voltage source converter comprises at least six self-commutated semiconductor switches, each of which shunted by a reverse parallel connected diode.

From U.S. Pat. No. 6,747,370 (Abe) a power compensation system using a high temperature secondary battery is previously known. The object of the compensation system is to provide an economical, high-temperature secondary battery based energy storage, which has a peak shaving function, a load leveling function and a quality stabilizing function. The known system comprises an electric power supply system, an electric load and an electric energy storage system including a high temperature secondary battery and a power conversion system. The battery is a sodium sulfur battery.

From U.S. Pat. No. 5,141,826 (Böhm) a high energy battery with a temperature regulating medium is previously known. The object of the medium is to provide a uniform temperature distribution within the battery. The disclosed battery consists of a sodium based battery which is operated at temperatures between 250 and 400° C. Thus the battery contains a plurality of battery cells arranged next to each other in a housing and a liquid or gaseous medium flowing within the housing to influence the temperature of the individual cells. The housing is provided with means for guiding the medium within the housing such that one or both ends of the cells are brought directly or indirectly in contact with the medium. For cooling purpose the battery is placed on a cooling plate through which a cooling liquid is pumped.

From EP 1 302 998 (Dustmann) a combined system containing battery means and solid oxide fuel cell is previously known. The object of the system is to provide a suitable propulsion source for a vehicle. The battery is of a sodium-nickel chloride or sodium-ion chloride type with a working temperature of approximately 300° C. For providing partly charging capacity and partly heat capacity the system contains a plurality fuel cells attached to the battery. The heat is provided by thermal conduction by a close connection between the fuel cells and the battery cells. For cooling the battery there are arranged in the battery a plurality of channels containing air which is being forced by a fan. The exhaust heat is used for heating the air of the passenger compartment of the vehicle.

### SUMMARY OF THE INVENTION

An exemplary object of the present invention is to seek ways to improve the temperature control of a high voltage, high temperature storage device to make it suitable for use in a power compensator of a high voltage power transmission line.

This object is achieved according to the invention by an energy storage device characterized by the features in the independent claim 1 or by a method characterized by the steps in the independent claim 6. Preferred embodiments are described in the dependent claims.

The high temperature storage device comprises a high temperature battery containing a plurality of sodium/metal chloride battery cells having an operating temperature in the range around 300° C. A battery unit comprises a heat insulated box containing a plurality of series connected battery cells. The battery unit has two terminals comprising an electric circuit in the range of 1.5 kV. Connecting four such battery units in series will thus reach a voltage level of 6 kV. The battery unit comprises a local pipe loop for housing a heat transfer medium in the form of a fluid. The fluid may be a liquid medium as well as a gaseous medium.

A criteria for the function of the battery, e.g. to be able to store and release electric energy, is that the temperature inside the battery cell is kept between 270 and 340° C. At operation mode such as when the battery is being charged or discharged heat is generated within the battery. At idling mode, however, no heat is generated inside the battery. Thus at the idling mode heat has to be provided from outside the battery. At operation mode and small currents there is also provided for additional heat from outside the battery.

According to the invention heat is transferred to the high temperature battery units by a heat transfer medium in the form of a fluid, such as a liquid or a gaseous medium. A temperature controller is arranged for maintaining the operation temperature of the battery unit. Thus the temperature controller is providing heat during the idling mode. The temperature controller contains a pipe network for providing a flow of the heat transfer medium through the battery units. The pipe network comprises a main pipe loop and at least one fluid moving unit, such as a fan or a pump. The pipe network includes the local pipe loop of each battery unit and provides a passageway for the heat transfer medium. The heat comprised in the heat transfer medium is transferred to the battery cells by convection.

According to an embodiment of the invention the local pipe loop comprises a first end for receiving a stream of a gaseous medium, and a second end for exhausting the gaseous medium. In an embodiment the gaseous medium comprises preferably air. Further the main pipe loop comprises an upstream side for providing hot air and a downstream side for receiving disposed air. Each first end of each local pipe loop is connected to the upstream side of the main pipe loop. Each second end of the each local pipe loop is connected to the downstream side of the main pipe loop. All connections between the main pipe loop and each local pipe loop comprises a connection pipe. The main pipe loop comprises at least one fan and a heat providing means. In an embodiment of the invention the main pipe loop is grounded and thus exhibits the ground potential. Each local pipe loop exhibit the same potential as the battery unit housing the local pipe loop. In a further embodiment each connection pipe comprises a tube of a heat resisting and electric insulating material, such as a ceramic material.

According to an embodiment of the invention the plurality of series connected battery units form a battery string. Each battery unit comprises a high number of battery cells, each having a voltage in the range of 1.7 and 3.1 V. The cells are connected in series which results in the battery unit, which in one exemplary embodiment may have a voltage of some 1.5 kV. In one embodiment four such battery units are connected in series which results in a total voltage of 6 kV. However in other embodiments many batteries are connected in series giving a total voltage in the range of 30-100 kV. The main pipe loop therefore is galvanically separated from the battery string. The connection pipes must thus be made of an electric insulating, heat resistible material. In an embodiment the connection pipe comprises a ceramic tube.

In an embodiment of the invention the temperature controller is also during the operation mode of the battery unit providing an air stream for disposal of heat generated from the battery cells. In a further embodiment of the invention the main pipe loop contains means for providing a cooling effect. In a first embodiment this cooling effect is provided by forcing ambient air through the local pipe loop. In a second embodiment the cooling effect is achieved by a heat exchanger connected to the main pipe loop.

According to an embodiment of the invention the heat conditioning system comprises an apparatus for controlling the temperature of the battery units. The control apparatus measures the temperature of each battery unit and controls the flow and temperature of the gaseous medium for maintaining the correct battery temperature. The temperature of each battery is measured by means of thermocouples, thermo resistors or similar and the temperature information is sent to the control apparatus. Each such sensor is galvanically isolated from the main pipe loop. Thus the sensor exhibits the same potential as the battery unit of sensing. Each sensor is provided with a local power supply and comprises a wireless transmission of information. Such wireless transmission means may comprise electro-magnetic transducers, opto fibers and the like.

According to an embodiment of the invention there is arranged on each galvanically isolated battery unit a communication module. The module comprises radio communication means, power supply and a plurality of sensing transducers. Also the communication module is galvanically isolated and thus achieving the same potential as the battery unit. The module may communicate within a wireless local area network, such as a WLAN or a Bluetooth network. The sensed values, such as voltage, current and temperature are preferably transmitted in digital form. To save power consumption the communication is arranged in short part of a time period. Thus the communication means need only be electrified during a small percentage of time. The communication may preferable take place within the 2 GHz band. The power supply comprises in one embodiment a back up battery and electric energy providing means. Such energy means may comprise any kind of generator configuration as well as a solar cell, peltier element, a fuel cell or other means.

In an embodiment of the invention the heat conditioning system comprises means for recirculation the gaseous medium. The means for providing the recirculation may comprise a valve in the main pipe loop. In an embodiment each upstream end of the main pipe loop comprises a separate valve on the inlet to each battery may be used to recirculate the hot exhaust air, which has a temperature in the order of 300 C, from the battery in order to make the heating more efficient. In an embodiment the recirculating valve is located at the central pipe instead.

In yet a further embodiment the recirculation of the gaseous medium is achieved by a short cut tube between the first end and the second end of the local pipe loop of a battery unit. The short cut tube comprises a fan and may comprise a heating element. In this embodiment the main pipe loop comprises in both the upstream and downstream connection to the local pipe loop a valve. By adjusting the valves the gaseous medium inside the local pipe loop may be recirculate completely or partly.

According to another embodiment of the invention the air heating is provided separately at each battery level. For this arrangement a plurality of heating elements are necessary but each element needs only a low power level compared to a central heating system for the whole battery system. The size and arrangement of the battery energy storage system may be decided upon desire.

Using the same central pipe or a separate parallel pipe system cooling of the batteries can also be made by supplying non-heated air to the batteries or even cooled air to low temperature to get a more efficient cooling.

During cooling the hot exhaust air from the batteries can be used to store heat in e.g. salts, phase change materials, soap-stone or similar materials. This stored heat can then be re-used during battery heating to get better energy efficiency. Also the hot exhaust air can be used e.g. for heating of the compensator building. Pre-heating of the air used for heating the batteries can also be made by utilizing the warm cooling water from the VSC valve itself, e.g. via heat exchangers or heat pumps.

In a first aspect of the invention the object is achieved by a temperature controller for providing heat to an energy storage device of a power compensator, the energy storage device comprising a plurality of high temperature battery units on high potential, the temperature controller comprising a pipe network for housing a heat transfer medium, wherein the pipe network comprises a main pipe loop and a local pipe loop in each battery unit, each local pipe loop having a first end for receiving a heat transfer medium and a second end for exhausting the medium, that the main pipe loop comprises a heat source and a fan, and that the pipe network comprises a connection pipe connecting each end of each local pipe loop with the main pipe loop for providing a continuous flow of the heat transfer fluid. In a further embodiment the connection pipe comprises a heat resisting and electrical insulating tube of a ceramic material. In yet a further embodiment the main pipe loop of the temperature controller further comprises a common heating system including a heater and a common fan. In still a further embodiment the temperature controller comprises a cooling loop with a cooler and a common cooling fan. In still a further embodiment the temperature controller further comprises a second loop passing through a heat exchanger for heat exchange with a second fluid system which may comprise cooling water from the voltage source converter valves.

In a second aspect of the invention the objects is achieved by a method for heat conditioning of a string of series connected high voltage, high temperature battery units, each battery unit comprising a local pipe loop having a first end for receiving a heat transfer medium and a second end for exhausting the medium, wherein the method comprises: providing a pipe network containing a main pipe loop connected to the local pipe loops, forcing a continuous flow of a heat transfer fluid, isolating each battery unit from the main pipe loop by inserting a connection pipe between each end of the local pipe loops and the main pipe loop, heating the heat transfer fluid to provide during an idling mode a heating effect on the battery. In a further embodiment the method further comprises cooling the heat transfer fluid to provide during an operation mode a cooling effect on the battery units.

### BRIEF DESCRIPTION OF THE DRAWINGS

Other features and advantages of the present invention will become more apparent to a person skilled in the art from the following detailed description in conjunction with the appended drawings in which:

FIG. 1 is a principal circuit of a part of an energy storage device according the invention,

FIG. 2 is a principal layout of a power compensator including a temperature controller and a charge controller,

FIG. 3 is a front view of a first embodiment of the temperature controller,

FIG. 4 is a side view of a first embodiment of the temperature controller,

FIG. 5 is a side view of a second embodiment of the temperature controller,

FIG. 6 is a side view of a third embodiment of the temperature controller,

FIG. 7 is a side view of a forth embodiment of the temperature controller,

FIG. 8 is a side view of a fifth embodiment of the temperature controller,

FIG. 9 is a side view of a sixth embodiment of the temperature controller,

FIG. 10 is a side view of a seventh embodiment of the temperature controller,

FIG. 11 is a side view of an eight embodiment of the temperature controller,

FIG. 12 is a side view of a ninth embodiment of the temperature controller, and

FIG. 13 is a side view of a tenth embodiment of the temperature controller.

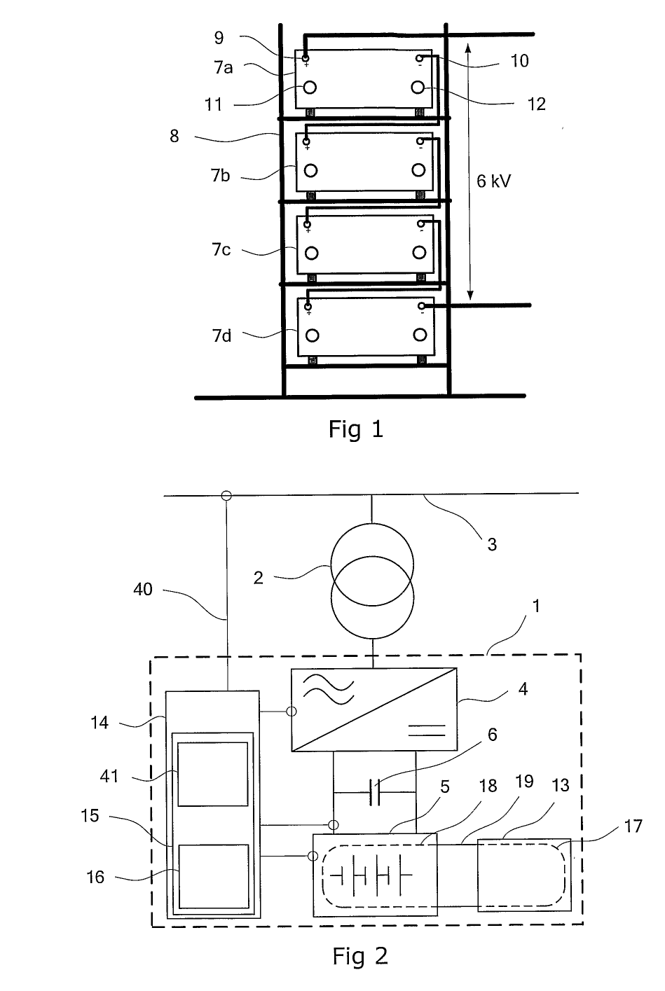

### DESCRIPTION OF PREFERRED EMBODIMENTS

In an exemplary embodiment the invention of a part of the energy storage device comprises a plurality of series connected battery units 7. In the embodiment shown in FIG. 2 being a part of a total energy storage device four battery units 7a-7d are arranged in a rack 8. Each battery unit has a positive terminal 9m and a negative terminal 10. In the embodiment shown each battery unit has a voltage of 1.5 kV thus the energy storage device containing four batteries connected in series has a voltage level of 6 kV. However there may also be many more batteries in series resulting in a much higher voltage level.

The energy storage device comprises high energy, high temperature batteries containing sodium/metal chloride battery cells having an operating temperature in the range of 270-340° C. Each battery unit comprises a heat insulated box containing a plurality of series connected battery cells. In operation such as charging or discharging the batteries produce heat. At the idling mode heat from outside the battery must be provided for keeping the operational temperature conditions. The battery unit therefore contains a local pipe loop having a first opening 11 for receiving a stream of a gaseous medium, and a second opening 12 for exhausting the gaseous medium.

A sodium/metal chloride battery cell comprises an electrolyte contained in a thin barrier of a ceramic material. When the battery is charged or discharged a reaction front is propagating inwardly from the ceramic barrier. Thus both the charging and discharging is propagating in the same direction and starting from the ceramic barrier. Resulting from a plurality of charging and discharging cycles there may be left inside the battery cell a plurality of areas defining power capacity areas and non-power capacity areas.

The schematic arrangement of four high voltage batteries connected in series. In this arrangement shown the highest battery potential will be 6 kV with respect to ground. In other cases a further plurality of batteries may be series connected giving very high battery potentials for the battery on top. The potential may reach the range of 10 kV up to 100 kV.

In further embodiment of the invention is shown in FIG. 2. In this embodiment the power compensator 1 comprises not only a voltage source converter 4 and an energy storage device 5 but also a temperature controller 13 and a control system 14 containing a charge controller 15. The charge controller comprises a module 16 for estimating the state of charge of the battery. The temperature controller 13 comprises a pipe network for housing a heat transfer medium. The pipe network comprises a main pipe loop 17, a local pipe loop 18 located in each battery unit and a plurality of connection pipes 19 connecting the main pipe loop with the local pipe loops. The temperature controller contains at least one heat providing means and a fluid moving unit for circulating the heat transfer medium in the pipe network. Hence by circulating the heat transfer medium through each battery heat is provided to the batteries by convection. In the embodiment shown the heat transfer medium comprises air and the fluid moving unit comprises a fan.

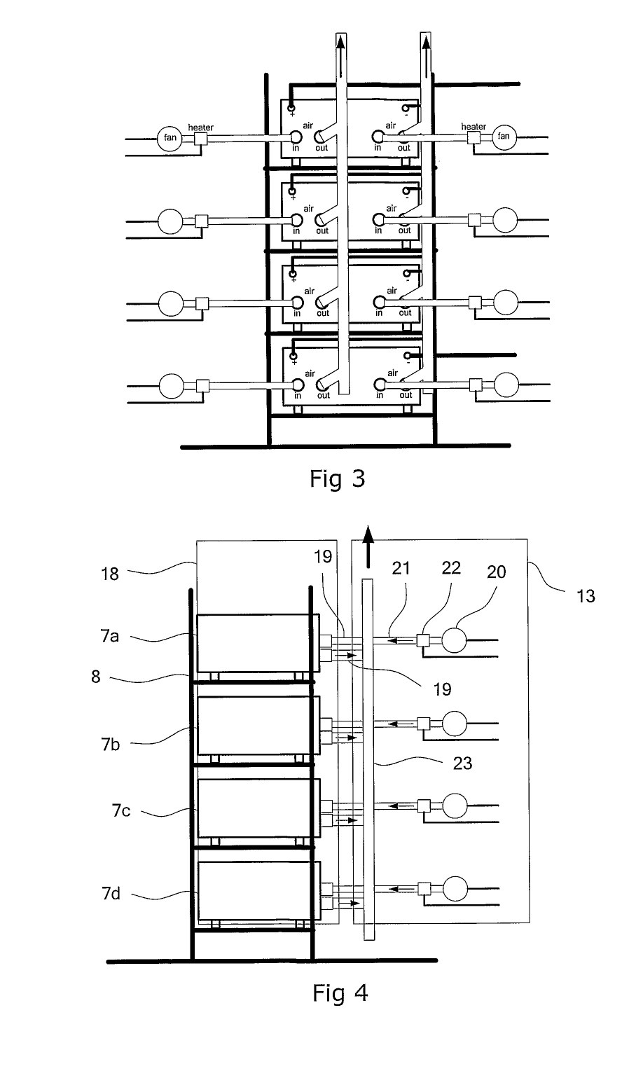

FIG. 3 shows an example of an arrangement for heating the batteries in the stack with separate fans connected to a heater on the air inlet connection on each battery. Depending on the situation only cold air without heating is supplied for cooling or if heating of the battery is necessary the inlet air is heated by the heater. On the outlet an exhaust “chimney” takes care of the hot exhaust air. The temperature control system controls how and when cooling air is supplied without heating, when heated air is supplied for heating of the batteries, or if no air is supplied.

FIG. 4 shows a side view of the arrangement in FIG. 3. The heaters and fans are on ground potential and can be fed by ordinary AC mains supply and the batteries are on high electrical potential. Therefore the connection to the batteries is made via electrical insulating and heat resistant tubes. The air has a temperature in the range of 300-400 C. Hence the tube is made of a ceramic material.

The temperature controller 13 is schematically divided into a main pipe loop 17 and a common local pipe loop 18. In this embodiment the local pipe loop exhibits a high voltage potential while the main pipe loop exhibits a ground potential. The connection pipes which connect the main pipe loop and the local pipe loop must not only exhibit an electric insulation but also withstand a fluid medium having a temperature of approximately 300° C. The main pipe loop in this embodiment comprises a separate fan 20 and a pipe part 21 for each battery unit. Each pipe part comprises a heat providing element 22 for heat delivery to the battery unit. The heat delivery unit may comprise a resistive element for connection to a low voltage electric power source.

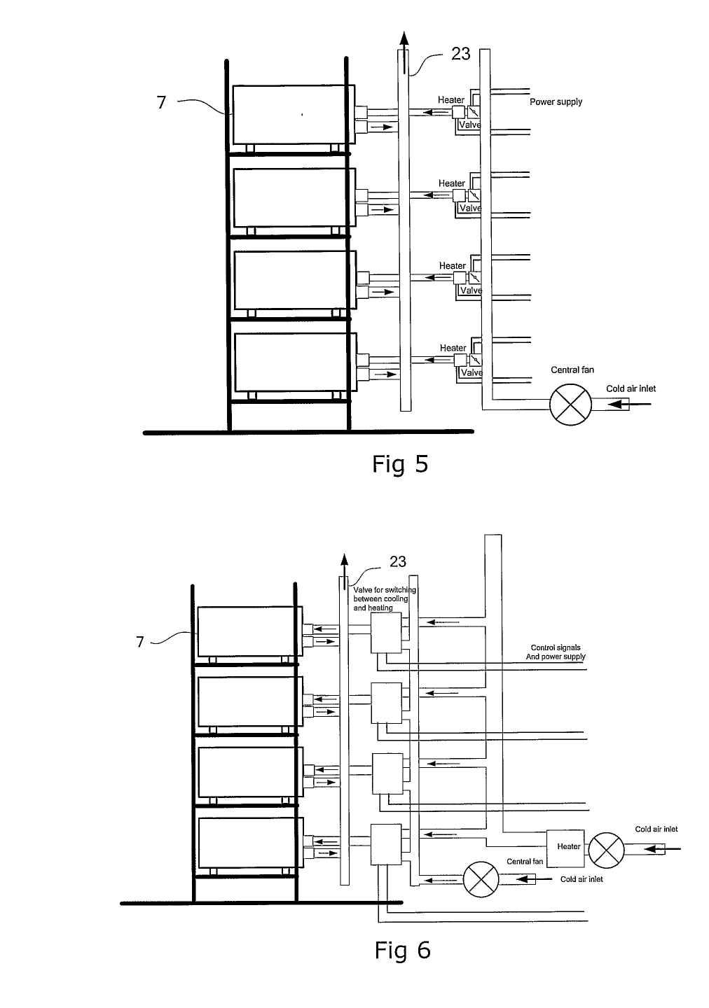

FIG. 5 shows a side view of an arrangement where the inlet air is supplied by a central fan feeding a central tubing system. At the inlet into each battery there is valve and heater controlled by the thermal control system. This system controls via the valve how and when cooling air is supplied. In one operation mode no air is supplied. In another operation mode heated air is supplied for heating of the batteries. In this operation the heater is on.

FIG. 6 shows a side view of an arrangement where the inlet cooling air is supplied by a central fan feeding a central tubing system and heating air is supplied by a similar separate central fan together with a central heater feeding a central tubing system. At the inlet into each battery there is a special valve which controls the inlet air to the battery: if no heating or cooling is necessary the valve shuts off the inlet, if heating is necessary the valve opens for the heated air into the battery and if cooling is necessary the valve opens for the cooling air into the battery.

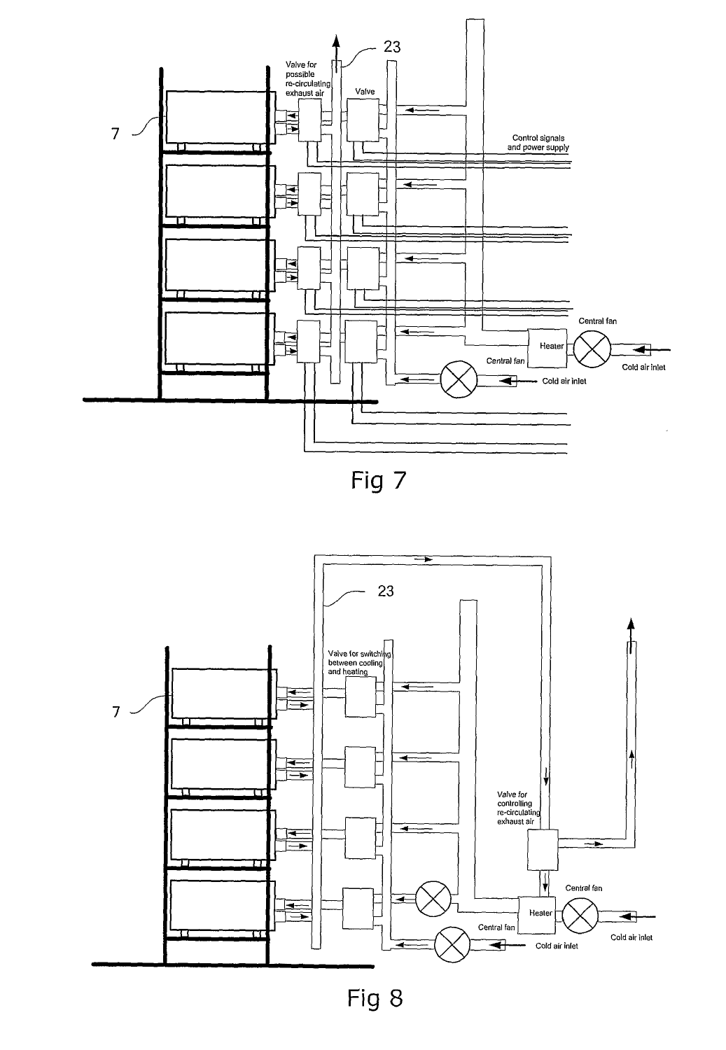

FIG. 7 shows a side view of a similar arrangement as in FIG. 6, but at the exhaust air outlet at each battery a special valve is located making it possible to re-circulate the hot exhaust air into the battery again in situations when heating is necessary. In this way the hot exhaust air can be re-used and thereby save energy for the heating.

FIG. 8 shows a side view of a similar arrangement as in FIG. 7, but the re-circulation of the hot exhaust air is made by a central valve feeding the hot air back into the inlet tubing at the central heater.

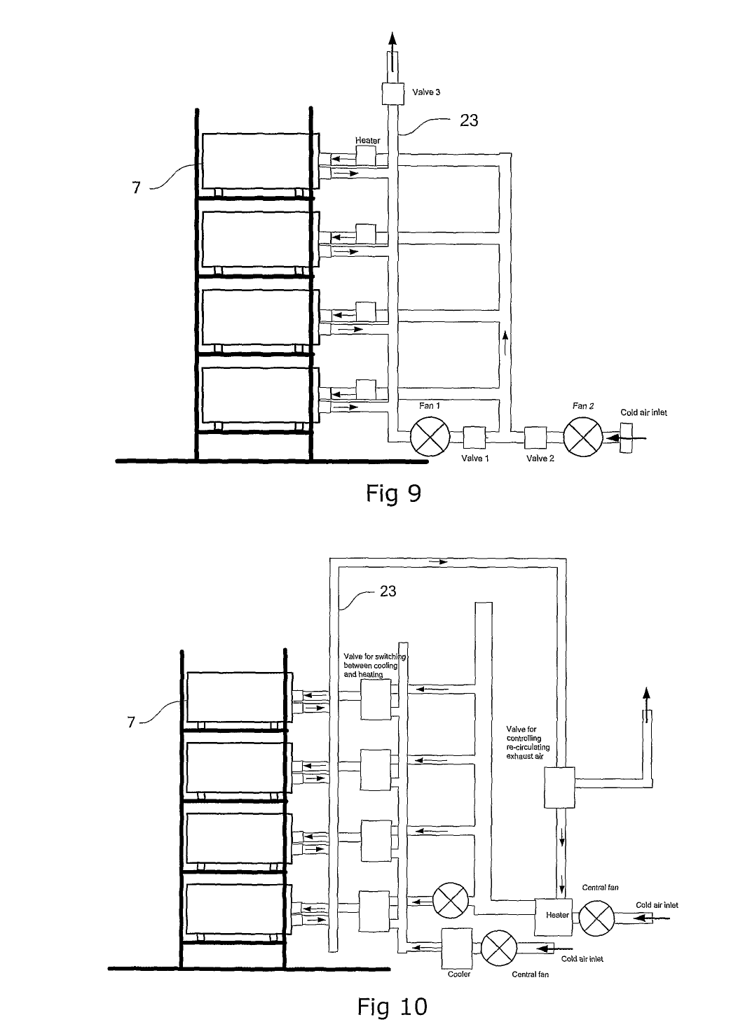

FIG. 9 shows a side view of a similar arrangement as in FIG. 7. The embodiment comprises a first fan and a first valve for regulating the re-circulation of the hot exhaust air. Further the embodiment comprises a second fan and a second valve for regulating the amount of hot air leaving the system. In this embodiment there are arranged for one heater for each battery unit.

FIG. 10 shows a side view of a similar arrangement as in FIG. 8 where the central cooling tubing is equipped with a cooler in order to increase the cooling efficiency of the batteries. In situations where the outside “cool” air is not cold enough this will increase the cooling capability of the batteries.

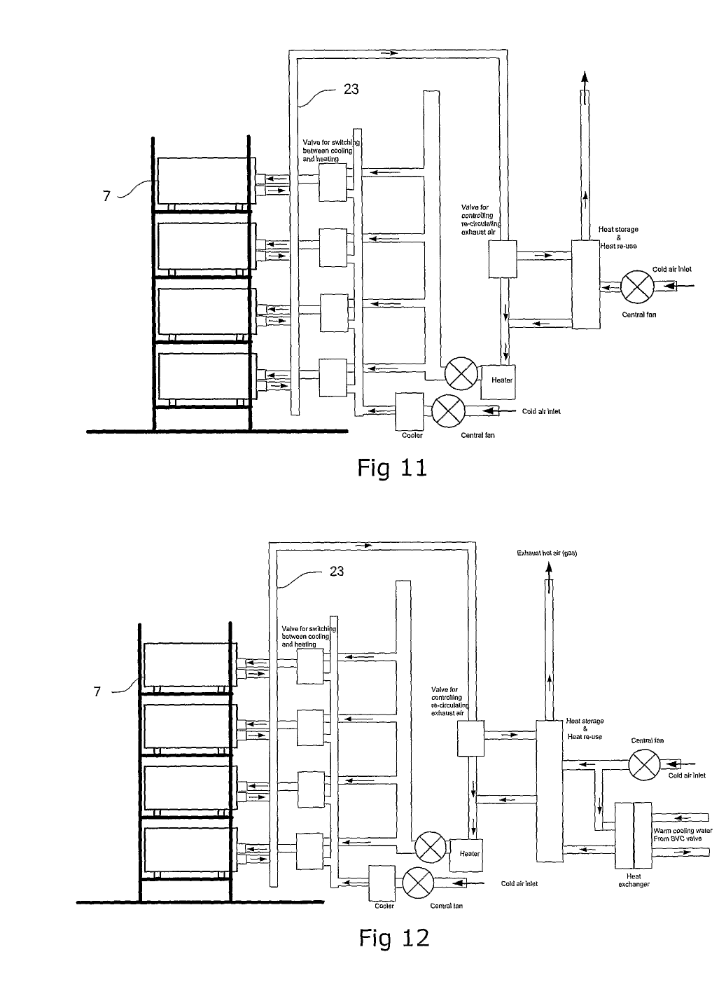

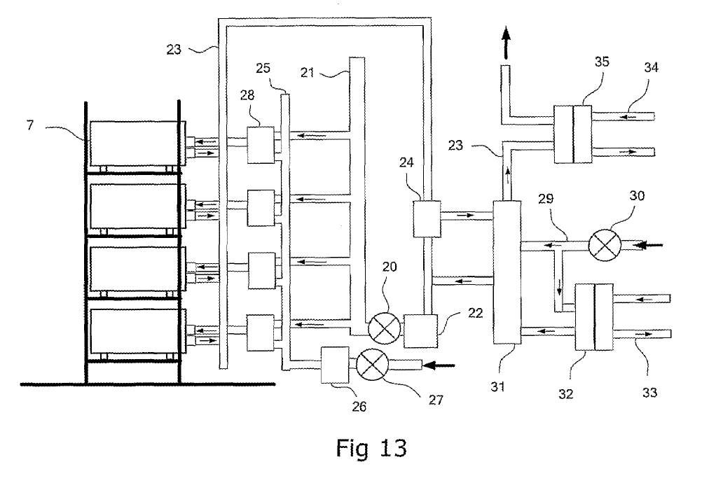

FIG. 11 shows a side view of a similar arrangement as in FIG. 10 but also equipped with a heat storage system on the exhaust air outlet. By this the energy in the warm exhaust air can be stored for use at a later time. When heating is necessary this heat energy can be re-used to pre-heat the inlet air taken into the heating tubing. This will save energy for heating of the batteries. The energy storage can be made by e.g. salts, phase change materials or similar materials. The re-use of this energy can be made by e.g. some kind of heat exchanger, heat pump etc.

FIG. 12 shows a side view of a similar arrangement as in FIG. 10, but also equipped with means to pre-heat the inlet air taken into the heating tubing by re-use of the warm cooling water from the VSC valve. The inlet air is heated from this cooling water through an arrangement with a heat exchanger.

A further development of a temperature controller is shown in FIG. 12. In this embodiment the main pipe loop of the temperature controller further comprises a common heating system 23 including a heater 22 and a common fan 20. According to this embodiment there is also provided for cooling of the battery units. Thus there is arranged a cooling loop 25 with a cooler and a common cooling fan 27. The provision of cooling or heating may be chosen by a switching valve 28. Also in the embodiment shown the heating system comprises an extension loop passing through a heat storage device 31. Further the system comprises a second loop 29 passing through a heat exchanger 32 for heat exchange with a second fluid system 33 which may comprise cooling water from the voltage source converter valves. The heating system also comprises a an extension loop passing through a second heat exchanger 35 for heat exchange with second heating system 34 which may be a heating system for a building.

Although favorable the scope of the invention must not be limited by the embodiments presented but contain also embodiments obvious to a person skilled in the art.

1. A temperature controller for providing heat to an energy storage device of a power compensator, the energy storage device comprising a plurality of high temperature battery units on high potential, the temperature controller comprising:
a pipe network for housing a heat transfer medium, wherein the pipe network comprises a main pipe loop and a local pipe loop in each battery unit, each local pipe loop having a first end for receiving a heat transfer medium and a second end for exhausting the medium, wherein the main pipe loop comprises a heat source and a fan, and wherein the pipe network comprises a connection pipe connecting each end of each local pipe loop with the main pipe loop for providing a continuous flow of the heat transfer fluid.

2. The temperature controller according to claim 1, wherein the connection pipe comprises a heat resisting and electrical insulating tube of a ceramic material.

3. The temperature controller according to claim 1, wherein the main pipe loop of the temperature controller further comprises a common heating system including a heater and a common fan.

4. The temperature controller according to claim 1, wherein the temperature controller comprises a cooling loop with a cooler and a common cooling fan.

5. The temperature controller according to claim 1, wherein the temperature controller further comprises a second loop passing through a heat exchanger for heat exchange with a second fluid system which may comprise cooling water from the voltage source converter valves.

6. A method for heat conditioning of a string of series connected high voltage, high temperature battery units, each battery unit comprising a local pipe loop having a first end for receiving a heat transfer medium and a second end for exhausting the medium, the method comprising:
providing a pipe network comprising a main pipe loop connected to the local pipe loops,
forcing a continuous flow of a heat transfer fluid,
isolating each battery unit from the main pipe loop by inserting a connection pipe between each end of the local pipe loops and the main pipe loop, and
heating the heat transfer fluid to provide during an idling mode a heating effect on the battery.

7. A method according to claim 6, further comprising:
cooling the heat transfer fluid to provide during an operation mode a cooling effect on the battery units.

8. A computer program product, comprising:
a computer readable medium; and containing
computer program instructions recorded on the computer readable medium and executable by a processor to carry out a method comprising providing a pipe network comprising a main pipe loop connected to local pipe loops, forcing a continuous flow of a heat transfer fluid, isolating each battery unit from the main pipe loop by inserting a connection pipe between each end of the local pipe loops and the main pipe loop, and heating the heat transfer fluid to provide during an idling mode a heating effect on the battery.

9. The computer program product according to claim 8, wherein the computer program instructions further comprise instructions for providing the instructions at least in part over a network.

10. The computer program product according to claim 9, wherein the network comprises the internet.

11. A power compensator for an electric power transmission line comprising
a voltage source converter and an energy storage device, wherein the energy storage device comprises a high voltage battery having a short circuit failure mode and a temperature controller comprising a pipe network for housing a heat transfer medium, wherein the pipe network comprises a main pipe loop and a local pipe loop in each battery unit, each local pipe loop having a first end for receiving a heat transfer medium and a second end for exhausting the medium, wherein the main pipe loop comprises a heat source and a fan, and wherein the pipe network comprises a connection pipe connecting each end of each local pipe loop with the main pipe loop for providing a continuous flow of the heat transfer fluid.

12. The power compensator according to claim 11, further comprising:
a charge controller for estimating the state of charge of the battery means.
